(19) United States
(12) Patent Application Publication
(10) Pub. No.: US 2026/0364991 A1
(43) Pub. Date: Nov. 19, 2026

(54) THERMAL REGULATION DEVICE, IN PARTICULAR FOR A MOTOR VEHICLE

(71) Applicant: VALEO ELECTRIFICATION, Cergy (FR)

(72) Inventors: Gael DURBECQ, Le Mesnil-Saint-Denis Cedex (FR); Kamel AZZOUZ, Le Mesnil-Saint-Denis Cedex (FR); Moussa NACER-BEY, Le Mesnil-Saint-Denis Cedex (FR)

(73) Assignee: VALEO ELECTRIFICATION, Cergy (FR)

(21) Appl. No.: 19/515,520

(22) PCT Filed: Sep. 2, 2024
(86) PCT No.: PCT/EP2024/074397

§ 371 Date: Mar. 2, 2026

(30) Foreign Application Priority Data
Sep. 4, 2023 (FR) FR2309285

(51) Int. Cl. B60H 1/00; B60H 1/32

(52) U.S. Cl. CPC B60H 1/00328; B60H 1/00278; B60H 1/32284

(57) ABSTRACT

A thermal regulation device including a first heat transfer fluid circuit having a distribution system with a plurality of distribution ports. The first circuit includes a plurality of branches connected to one of the distribution ports. The distribution system is configured to assume different positions intended to bring at least some of the branches into communication with one another. The distribution system includes a distributor member intended to be rotatably movable in order to selectively supply the branches to be connected to one another, at least two of the branches being connected to an exchanger intended to exchange heat with a refrigerant. The device further includes a second heat transfer fluid circuit that has an exchanger intended to exchange heat with the refrigerant.

### TECHNICAL FIELD OF THE INVENTION

The invention relates to a thermal regulation device, in particular for a motor vehicle.

### TECHNICAL BACKGROUND

Fluid circuits are known that allow thermal conditioning of different members or zones of a motor vehicle, in particular its batteries and/or its passenger compartment. With the increasing number of hybrid or electric drive systems, these circuits have numerous branches in order to allow the needs for thermal management of the vehicle to be met in various operating modes.

In order to circulate the fluid in their different branches, such circuits comprise a large number of valves that connect the branches to each other according to different configurations depending on the desired operating mode. Such a number of valves increases the pressure losses. In addition, they make control of the circulation of the fluid more complex and increase the cost of these circuits.

Rotary valves have also been proposed, such valves allowing numerous inlets/outlets to be connected in order to offer more possibilities for circulating the fluid between the branches of the circuit compared to the standard two-, three-, or four-way valves. However, there remains a need to improve the associated circuits in order to limit the complexity thereof while retaining a large number of possible operating modes.

### SUMMARY OF THE INVENTION

The present invention aims to at least partially overcome the aforementioned drawbacks and to this end proposes a thermal regulation device comprising a first circuit of first heat transfer fluid, said first circuit of first heat transfer fluid comprising a system for distributing said first heat transfer fluid having a plurality of orifices for distributing said first heat transfer fluid, said first circuit of first heat transfer fluid further comprising a plurality of branches respectively connected to one of said distribution orifices, said distribution system being configured to adopt different positions respectively intended to place at least some of said branches in communication with each other, said distribution system comprising a distribution member, said distribution member being intended to be able to rotate about a longitudinal axis in order to selectively feed said branches to be connected to each other as a function of angular positions of said distribution member, at least two of said branches being connected to an exchanger, referred to as the first two-fluid exchanger, intended to exchange heat with a refrigerant, said device comprising a second circuit of heat transfer fluid, said second circuit of heat transfer fluid comprising an exchanger, referred to as the second two-fluid exchanger, intended to exchange heat with said refrigerant.

By providing two separate heat transfer fluid circuits, it is possible to limit the number of valves to be used in addition to the multi-way distribution system, while benefiting from a large number of possible operating modes by virtue of the combination of said two-fluid exchangers.

The device according to the invention can further comprise one or more of the features below, taken in isolation from one another or in combination with one another:
said device comprises a so-called specific heat exchanger, intended to exchange heat between the first heat transfer fluid and the heat transfer fluid circulating in said second circuit,
said device is configured so that said heat transfer fluid circulating in said second circuit is the same type as said first heat transfer fluid,
said first circuit of first heat transfer fluid is configured so that said first heat transfer fluid circulates from and to the distribution system, passing through said first two-fluid exchanger without passing through a pump,
said first circuit of first heat transfer fluid comprises at least five branches connected to said distribution system,
in said first circuit of first heat transfer fluid:
   a first of said branches comprises a heat exchanger, referred to as the electrical energy storage system heat exchanger,
   a second of said branches is connected to said first two-fluid exchanger,
   a third of said branches comprises an exchanger, referred to as the first exterior exchanger, intended to exchange heat with a second heat transfer fluid,
   a fourth of said branches comprises a first pump and, optionally, a heat exchanger, referred to as the electrical system heat exchanger,
   a fifth of said branches is connected to said first two-fluid exchanger,
   a sixth of said branches comprises said specific exchanger, or even a second pump, and/or
   a seventh of said branches is configured to bypass the third branch,
said second pump can be situated equally on the first of said branches or on the sixth of said branches,
said first circuit of first heat transfer fluid is configured so that one of the angular positions of the distribution member, referred to as the first position, makes it possible to form a first loop comprising said first, second, fifth, and sixth branches and a second loop comprising said third and fourth branches,
said first circuit of first heat transfer fluid or said second circuit of heat transfer fluid further comprises a so-called electric heat exchanger, intended to heat said fluid using an electric current,
said electric heat exchanger is situated on said first branch or said sixth branch of the first circuit of first heat transfer fluid,
said device is configured so that said sixth branch of the first circuit of first heat transfer fluid supplies said first branch of the first circuit of first heat transfer fluid with first heat transfer fluid in all of the angular positions of said distribution member,
said device comprises a divergence point, situated at a first end of said fourth branch of the first circuit of first heat transfer fluid, said first end of said fourth branch being opposite a second end of said fourth branch connected to said distribution system,
said divergence point is connected to said third branch of the first circuit of first heat transfer fluid and to said seventh branch of the first circuit of first heat transfer fluid,
said device is configured so that said first heat transfer fluid is a cooling liquid,
said device is configured so that said second heat transfer fluid is a first air stream referred to as the exterior air stream,
said device comprises a refrigerant circuit,
said refrigerant circuit comprises said first and second two-fluid exchangers,
said refrigerant circuit comprises a main loop comprising, in a direction of circulation of said refrigerant in said main loop, a compressor, said second two-fluid exchanger, an expansion member, and said first two-fluid exchanger,
said main loop comprises a so-called main branch, provided with said compressor and said second two-fluid exchanger,
said refrigerant circuit comprises a first bypass branch, situated in parallel with said main branch, said first bypass branch comprising a so-called cooling exchanger, intended to directly or indirectly cool a second air stream referred to as the interior air stream,
said cooling exchanger comprises an exchanger, referred to as the first interior exchanger, intended to exchange heat directly between said refrigerant and the interior air stream,
said cooling exchanger comprises a third two-fluid exchanger, intended to exchange heat between said refrigerant and a heat transfer fluid circulating in a third circuit of heat transfer fluid,
said third circuit of heat transfer fluid comprises a cooling radiator, intended to exchange heat between said heat transfer fluid circulating in the third circuit of heat transfer fluid and said interior air stream,
said refrigerant circuit comprises a second bypass branch, in parallel with said second two-fluid exchanger, said second bypass branch comprising an exchanger, intended to exchange heat between said refrigerant and the interior air stream,
said second circuit of heat transfer fluid comprises a first branch comprising said specific exchanger,
said second circuit of heat transfer fluid comprises a second branch, situated in parallel with said first branch of said second circuit of heat transfer fluid, said second branch of the second circuit of heat transfer fluid comprising said second two-fluid exchanger,
said second circuit of heat transfer fluid comprises a third branch, situated in parallel with said first branch of said second circuit of heat transfer fluid, said third branch of the second circuit of heat transfer fluid comprising an exchanger, referred to as the second exterior exchanger, intended to exchange heat between said first fluid and said exterior air stream,
said second circuit of heat transfer fluid comprises a fourth branch, situated in parallel with said first branch of said second circuit of heat transfer fluid, said fourth branch of the second circuit of heat transfer fluid comprising an exchanger allowing heat exchange between said heat transfer fluid of said second circuit of heat transfer fluid and said interior air stream,
said second circuit of heat transfer fluid comprises a three-way valve connecting said first, second, and third branches of said second circuit of heat transfer fluid,
said second circuit of heat transfer fluid comprises a four-way valve connecting said first, second, third, and fourth branches of said second circuit of heat transfer fluid,
said device is configured to operate without direct heat exchange between the first fluid of the first circuit of first heat transfer fluid and the heat transfer fluid of said second circuit of heat transfer fluid,
said distribution member comprises a body having:
   a first fluid distribution channel, extending axially along the longitudinal axis, and
   a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel,
the first distribution channel is centered on the longitudinal axis,
the first chamber is intended to be in communication with no more than one of the peripheral channels, whatever the angular position of the body,
the body has one or more second chambers opening radially such that angular positions of said body determine a passage for the fluid between different of said peripheral inlet and/or outlet channels of said distribution system, through the or at least one of the second chamber or chambers,
the first and/or second chambers extend angularly about the longitudinal axis,
the body comprises arms connected to each other through a central portion, said arms extending from said central portion to lateral edges of said body, said arms defining at least one of said chambers,
said distribution system forms a valve,
said valve comprises a casing defining a housing for said distribution member, the casing being provided with said peripheral inlet and/or outlet channels.

### BRIEF DESCRIPTION OF THE FIGURES

Further features and advantages of the invention will become apparent on reading the following detailed description, which will be more clearly understood with reference to the appended drawings, in which:

FIG. 1 schematically shows a first example of a regulation device according to the invention, used according to a first operating mode,

FIG. 2 schematically shows a second operating mode of the regulation device in FIG. 1,

FIG. 3 schematically shows a third operating mode of the regulation device in FIG. 1,

FIG. 4 schematically shows a fourth operating mode of the regulation device in FIG. 1,

FIG. 5 schematically shows a fifth operating mode of the regulation device in FIG. 1,

FIG. 6 schematically shows a sixth operating mode of the regulation device in FIG. 1,

FIG. 7 schematically shows a second example of a regulation device according to the invention, used according to a first operating mode,

FIG. 8 schematically shows a second operating mode of the regulation device in FIG. 7,

FIG. 9 schematically shows a third operating mode of the regulation device in FIG. 7,

FIG. 10 schematically shows a fourth operating mode of the regulation device in FIG. 7,

FIG. 11 schematically shows a fifth operating mode of the regulation device in FIG. 7,

FIG. 12 schematically shows a sixth operating mode of the regulation device in FIG. 7,

FIG. 13 schematically shows a third example of a regulation device according to the invention, used in a first operating mode,

FIG. 14 schematically shows a second operating mode of the regulation device in FIG. 13,

FIG. 15 schematically shows a third operating mode of the regulation device in FIG. 13,

FIG. 16 schematically shows a fourth operating mode of the regulation device in FIG. 13,

FIG. 17 schematically shows a fifth operating mode of the regulation device in FIG. 13,

FIG. 18 schematically shows a sixth operating mode of the regulation device in FIG. 13,

FIG. 19 schematically shows, in perspective, an example of a distribution member of a distribution system of a thermal regulation device according to the invention,

FIG. 20 schematically shows, in a transverse section plane, the distribution member in FIG. 19,

FIG. 21 is an exploded view of distribution system comprising the distribution member in FIG. 19,

FIG. 22 schematically shows, in perspective, the distribution system in FIG. 21,

FIG. 23 is an exploded view of another distribution system comprising the distribution member in FIG. 19,

FIG. 24 schematically shows, in an axial section plane, the distribution system in FIG. 23,

FIG. 25 schematically shows a fourth example of a regulation device according to the invention,

FIG. 26 schematically shows a fifth example of a regulation device according to the invention,

FIG. 27 schematically shows a sixth example of a regulation device according to the invention.

In these figures, the same reference sign corresponds to identical or similar elements.

### DETAILED DESCRIPTION OF THE INVENTION

Firstly, it will be noted that the terms upstream and downstream used in the following description relate to the direction of circulation of the fluid in question. In addition, the terms “first”, “second”, “third”, etc., are used solely to distinguish the components in question from each other, and do not indicate any order or any potential importance of said components.

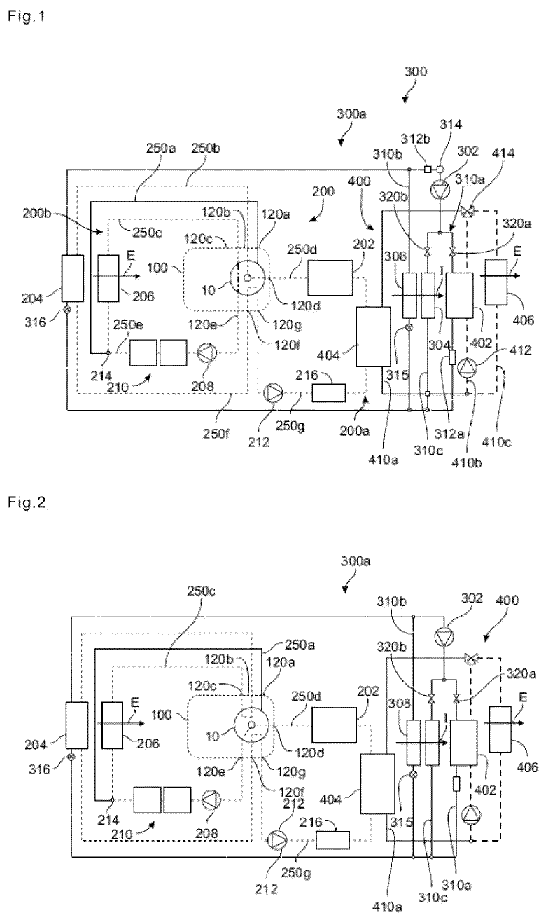

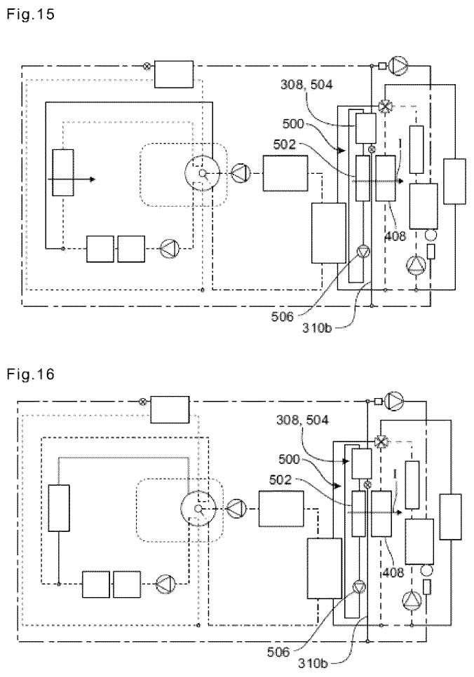

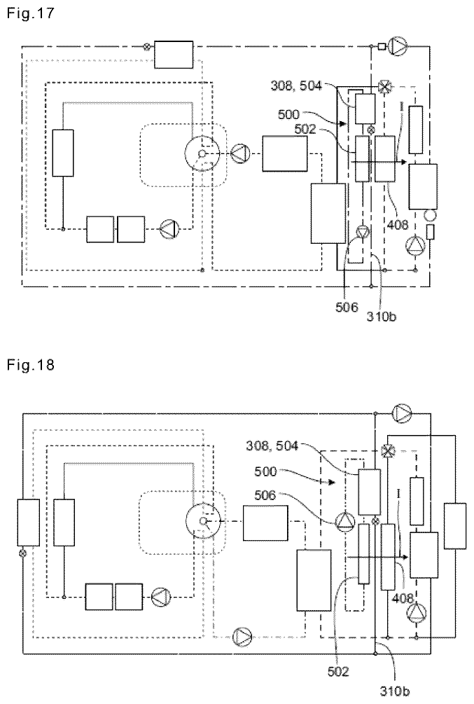

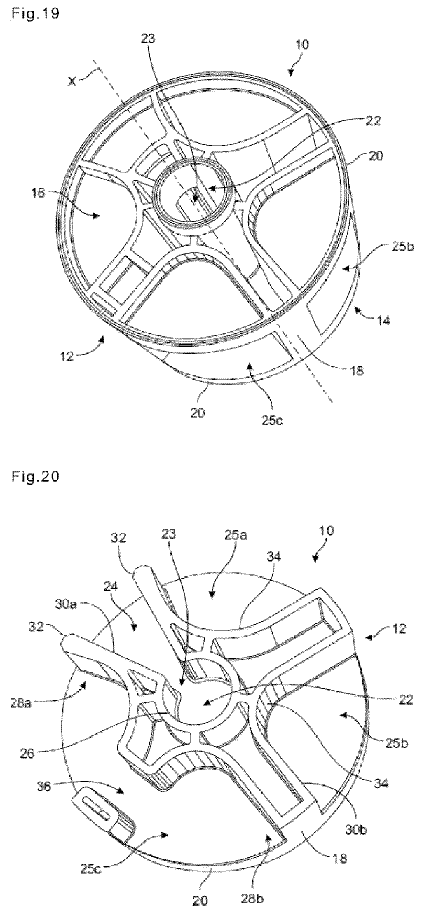

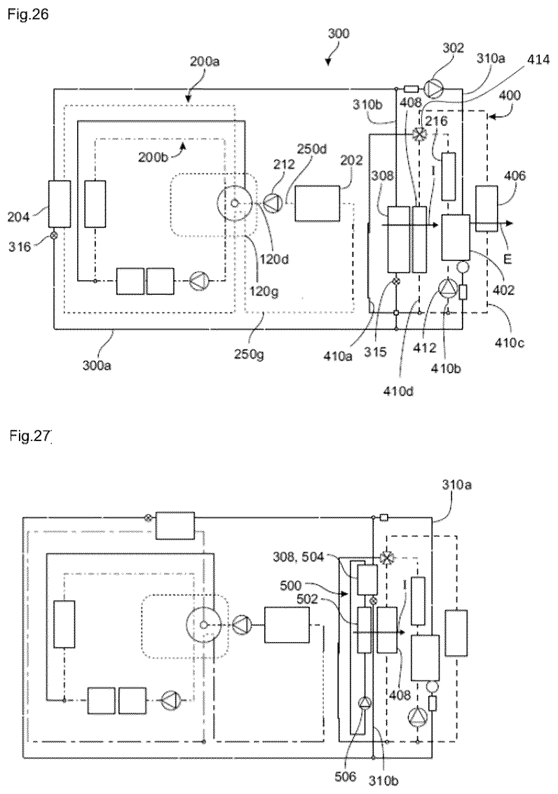

As shown in FIGS. 1 to 18 and 25 to 27, the invention relates to a thermal regulation device. It is intended, in particular, for motor vehicles, particularly electric motor vehicles. It is for example used for the thermal regulation of various members or zones of motor vehicles, particularly the batteries, the drive system, and/or the passenger compartment thereof.

Said thermal regulation device comprises a first circuit 200 of first heat transfer fluid. Said first heat transfer fluid is for example a liquid, in particular a mixture of water and an antifreeze product such as glycol. Alternatively, it is for example a dielectric fluid such as oil.

Said first circuit 200 of first heat transfer fluid comprises a system 100 for distributing said first heat transfer fluid and a plurality of branches 250a-250g respectively connected to one among distribution orifices 120a-120g of said distribution system 100.

Said distribution system 100 is intended to place at least some of said branches 250a-250g in communication with each other according to various configurations of said system. For this, said distribution system comprises a distribution member 10 in order to selectively feed said branches 250a-250g to be placed in communication with each other as a function of positions, in particular angular positions, of said distribution member 10. To this end, said distribution member 10 is preferably intended to able to rotate about a longitudinal axis.

At least two of said branches 250b, 250f of the first circuit 200 of first heat transfer fluid are connected to an exchanger 204, referred to as the first two-fluid exchanger, intended to exchange heat with a refrigerant.

Said device further comprises a second circuit 400 of heat transfer fluid. Said second circuit 400 of heat transfer fluid comprises an exchanger 402, referred to as the second two-fluid exchanger, also intended to exchange heat with said refrigerant.

Preferably, according to the embodiment in FIGS. 1 to 18, said device further comprises a so-called specific heat exchanger 404, intended to exchange heat between the first heat transfer fluid of the first circuit 200 and the heat transfer fluid circulating in said second circuit 400 of heat transfer fluid.

As a variant, as shown in FIGS. 25 to 27, said device is configured to operate without direct heat exchange between the first fluid of the first circuit 200 of first heat transfer fluid and the heat transfer fluid of said second circuit 400 of heat transfer fluid. In other words, in this variant, said specific exchanger 404 is not present.

Said device is preferably configured so that said heat transfer fluid circulating in said second circuit 400 is the same type as said first heat transfer fluid, for example water with antifreeze. As a variant, there are two different types of heat transfer fluid, for example a dielectric fluid for the first heat transfer fluid and water with antifreeze for the heat transfer fluid circulating in said second circuit 400 of heat transfer fluid.

By creating two separate loops of heat transfer fluid, namely the first circuit 200 of first heat transfer fluid and the second circuit 400 of heat transfer fluid, and by providing one of them, in this instance the first circuit 200 of first heat transfer fluid, with said multi-way distribution system 100, it is possible to limit the number of valves to be used to control the circulation of said heat transfer fluid or fluids while retaining a large number of possible operating modes.

Preferably, there are at least five of said branches 250a-250g of the first circuit 200 of first heat transfer fluid. There are seven of them here:
a first 250d of said branches, connected to a first 120d of the communication orifices, comprises a heat exchanger 202, referred to as the electrical energy storage system heat exchanger,
a second 250b of said branches, connected to a second 120b of the communication orifices, is connected to the first two-fluid exchanger 204,
a third 250c of said branches, connected to a third 120c of the communication orifices, comprises an exchanger 206, referred to as the first exterior exchanger, intended to exchange heat with a second heat transfer fluid, identified here by an arrow denoted E,
a fourth 250e of said branches, connected to a fourth 120e of the communication orifices, comprises a first pump 208 and, optionally, a heat exchanger 210, referred to as the electrical system heat exchanger,
a fifth 250f of said branches, connected to a fifth 120f of the communication orifices, is connected to said two-fluid exchanger 204,
a sixth 250g of said branches, connected to a sixth 120g of the communication orifices, optionally comprises said specific exchanger 404, or even a second pump 212, and/or
a seventh 250a of said branches, connected to the seventh 120a of the communication orifices, is configured to bypass the third branch 250c.

Electrical energy storage system heat exchanger 202 is given to mean an exchanger that allows direct or indirect heat exchange with said storage system.

In other words, according to a first variant, said storage system heat exchanger 202 is incorporated into said storage system and allows the first heat transfer fluid to pass through said storage system, cooling it or heating it. Said first heat transfer fluid is in this case preferably a dielectric fluid so that it can be placed in contact with the electrical components of said storage system.

According to another variant, said device comprises a circuit of a first specific fluid for thermally regulating said storage system. Said circuit of first specific fluid comprises said storage system heat exchanger 202 and said storage system, as well as a first specific pump for driving said first specific fluid. Said storage system exchanger 202 is in this case intended to exchange heat between said first heat transfer fluid and said first specific fluid. Said first specific fluid is in this case preferably a dielectric fluid, and the first heat transfer fluid is advantageously water with the addition of antifreeze, subject to the method of heat exchange with said electrical system, as set out below.

Said storage system is for example made up of one or more electric batteries.

Electrical system heat exchanger 210 is given to mean an exchanger that allows direct or indirect heat exchange with said electrical system.

In other words, according to a first variant, said electrical system heat exchanger 210 is incorporated into said electrical system and allows the first heat transfer fluid to pass through said electrical system, cooling it or heating it. Said first heat transfer fluid is in this case preferably a dielectric fluid so that it can be placed in contact with the electrical components of said electrical system.

According to another variant, said device comprises a circuit of a second specific fluid for thermally regulating said electrical system. Said circuit of second specific fluid comprises said electrical system heat exchanger 210 and said electrical system, as well as a second specific pump for driving said second specific fluid. Said electrical system exchanger 210 is in this case intended to exchange heat between said first heat transfer fluid and said second specific fluid. Said second specific fluid is in this case preferably a dielectric fluid, and the first heat transfer fluid is advantageously water with the addition of antifreeze, subject to the method of heat exchange with said electrical energy storage system, as set out above.

Said electrical system comprises for example an electric machine used to drive the vehicle and/or an electronic system for controlling said electric machine.

Said device is configured so that said second heat transfer fluid is for example a first air stream, referred to as the exterior air stream. Said first exterior exchanger 206 is intended to be situated, in particular, on a front face of the vehicle so that said exterior air stream E can pass through it, said exterior air stream E having first passed through a grille of the vehicle. Said first exterior exchanger 206 is formed for example by a front face radiator.

Here, said device comprises a divergence point 214, situated at a first end of said fourth branch 250e. Said first end of the fourth branch 250e is opposite a second end of said fourth branch 250e connected to said distribution system 100 at its fourth distribution orifice 120e. Said divergence point is connected to said third branch 250c and to said seventh branch 250a respectively, by one of their ends opposite the end connected to said distribution system 100 at its third and seventh distribution orifices 120c, 120a. The first heat transfer fluid arriving at the divergence point 214 can therefore, depending on the positions of the distribution member 10, either pass through the first exterior exchanger 206 by taking the third branch 250c, or bypass said first exterior exchanger 206 by taking said seventh branch 250a, before returning to said distribution system 100.

In said fourth branch 120e, the first pump 208 and said electrical system exchanger 210 are situated in series in that order in the direction of circulation of said first heat transfer fluid from said fourth distribution orifice 120e toward said divergence point 214. According to another embodiment, not shown, said electrical system exchanger 210 and said pump 208 could be situated in series in that order in the direction of circulation of said first heat transfer fluid from said fourth distribution orifice 120e toward said divergence point 214.

Preferably, said circuit 200 of first heat transfer fluid is configured so that said first heat transfer fluid circulates in said second and fifth branches 250b and 250f, from and to the distribution system 100, passing through said two-fluid exchanger 204 without passing through the pumps 208, 212 of said first circuit of first heat transfer fluid.

Preferably again, said circuit 200 of first heat transfer fluid is configured so that one of the angular positions of the distribution member, referred to as the first position, makes it possible to form a first loop 200a comprising said first, second, fifth, and sixth branches 250d, 250b, 250f, 250g and a second loop 200b comprising said third and fourth branches 250c, 250e. Such a configuration will be described below with reference to FIGS. 1, 7, and 13.

More preferably, said device is configured so that said sixth branch 250g supplies said first branch 250d with first heat transfer fluid in all of the angular positions of said distribution member 10.

According to the embodiments in FIGS. 1 to 6 and 25, said sixth branch 250g comprises said second pump 212 of the first circuit 200 of first heat transfer fluid. In other words, said second pump 212 is situated upstream of said electrical energy storage system exchanger 202 in the direction of circulation of said first heat transfer fluid in said first and sixth branches 250d, 250g. More specifically, here, said second pump 212 is situated upstream of said specific heat exchanger 404 in the direction of circulation of the first heat transfer fluid in said first and sixth branches 250d, 250g. According to another embodiment, not shown, the second pump 212 could be situated at any point on the first and sixth branches 250d, 250g.

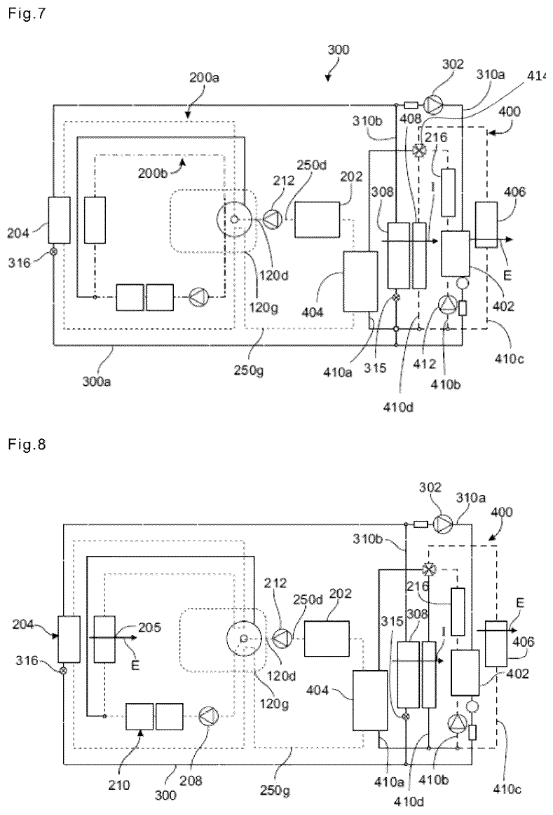

As a variant, according to the embodiments in FIGS. 7 to 18, 26, and 27, said second pump 212 of the first circuit 200 of first heat transfer fluid is situated on said first branch 250d. Here, it is situated downstream of said electrical energy storage system exchanger 202 in the direction of circulation of said first heat transfer fluid in said first and sixth branches 250d, 250g.

Said first circuit 200 of first heat transfer fluid or said second circuit 400 of heat transfer fluid further comprises a so-called electric heat exchanger 216, intended to heat said fluid using an electric current.

According to the embodiment in FIGS. 1 to 6 and 25, said electric heat exchanger 216 is situated on said first branch or said sixth branch 250d, 250g of the first circuit 200 of first heat transfer fluid. More specifically, here, it is situated on said sixth branch 250g, downstream of said second pump 212 and/or upstream of said specific exchanger 404, in the direction of circulation of the first heat transfer fluid in said first and sixth branches 250d, 250g.

According to the different embodiments shown in FIGS. 1 to 18, said second circuit 400 of heat transfer fluid comprises a first branch 410a comprising said specific exchanger 404, a second branch 410b, situated in parallel with said first branch 410a of said second circuit 400 of heat transfer fluid, said second branch 410b of the second circuit 400 of heat transfer fluid comprising said second two-fluid exchanger 402, and a third branch 410c, situated in parallel with said first branch 410a of said second circuit 400 of heat transfer fluid, said third branch 410c of the second circuit 400 of heat transfer fluid comprising an exchanger 406, referred to as the second exterior exchanger, intended to exchange heat between said heat transfer fluid and said exterior air stream E.

Said second exterior exchanger 406 is intended to be situated, in particular, on the front face of the vehicle so that said exterior air stream E can pass through it, said exterior air stream E having first passed through the grille of the vehicle. Said second exterior exchanger 406 is formed for example by a low-temperature radiator. It is intended to be situated in series or in parallel with the first exterior exchanger 206 in said exterior air stream E, for example downstream of said first exterior exchanger 206 in the direction of circulation of said exterior air stream E.

Said second circuit 400 of heat transfer fluid further comprises a third pump 412. Here, it is situated on said second branch 410b of the second circuit 400 of heat transfer fluid.

According to the embodiments in FIGS. 7 to 18, 26, and 27, said electric exchanger 216 is situated in said second circuit 400 of heat transfer fluid. Here, it is situated on said second branch 410b, for example so that said second two-fluid exchanger 402 is between said third pump 412 and said electric exchanger 216. It makes it possible to heat said heat transfer fluid of said second circuit 400 of heat transfer fluid.

Still according to the embodiments in FIGS. 7 to 18, 26, and 27, said second circuit 400 of heat transfer fluid comprises a fourth branch 410d situated in parallel with said first branch 410a of said second circuit 400 of heat transfer fluid.

Said fourth branch 410d of the second circuit 400 of heat transfer fluid comprises an exchanger 408, referred to as the second interior exchanger, allowing heat exchange between said heat transfer fluid of said second circuit 400 of heat transfer fluid and a second air stream, referred to as the interior air stream, identified by an arrow denoted I. Said interior air stream I is intended to circulate in the passenger compartment for the thermal regulation thereof. Said second interior exchanger 408 is configured to be positioned in a heating, ventilation and/or air conditioning unit situated for example under a dashboard of the vehicle. It can for example be a heating radiator.

Said second circuit 400 of heat transfer fluid comprises a valve 414 connecting said first, second, third, and/or fourth branches 410a-410d of said second circuit 400 of heat transfer fluid. In the embodiment in FIGS. 1 to 6, it is a three-way valve. In the embodiment in FIGS. 7 to 18, it is a four-way valve.

Preferably, said device further comprises a refrigerant circuit 300. Said refrigerant circuit 300 is configured to perform a thermodynamic cycle, in particular having a compression phase, a first heat exchange phase, an expansion phase, and a second heat exchange phase. It is configured to operate reversibly, that is, in both heat pump mode and air conditioning mode. Said refrigerant circuit 300 comprises said first and second two-fluid exchangers 204, 402.

The refrigerant is for example a sub-critical fluid, such as those known by the name R134a or R1234yf. As a variant, it is a super-critical fluid such as CO2 or R744. As a further variant, it is propane.

Here, said refrigerant circuit comprises a main loop 300a. Said main loop 300a comprises, in a direction of circulation of said refrigerant in said main loop, a compressor 302, the second two-fluid exchanger 402, and said first two-fluid exchanger 204. Said main loop comprises a so-called main branch 310a, provided with said compressor 302 and said second two-fluid exchanger 402.

Said refrigerant circuit 300 further comprises a first bypass branch 310b, situated in parallel with said main branch 310a in said main loop 300a. Said first bypass branch 310b comprises a so-called cooling exchanger 308, intended to directly or indirectly cool the interior air stream I. Said first bypass branch 310b further comprises a first expansion member 315, situated upstream of said cooling exchanger 308 in the direction of circulation of said refrigerant in said first bypass branch 310b.

According to the embodiments in FIGS. 1 to 12, 25, and 26, said cooling exchanger 308 is formed by an exchanger, referred to as the first interior exchanger, intended to exchange heat directly between said refrigerant and the interior air stream I. Said first interior exchanger 308 is configured to be positioned in the heating, ventilation and air conditioning unit. It is for example an evaporator. In the embodiment in FIGS. 7 to 12, it is upstream of the second interior exchanger 408 in the direction of circulation of the interior air stream I.

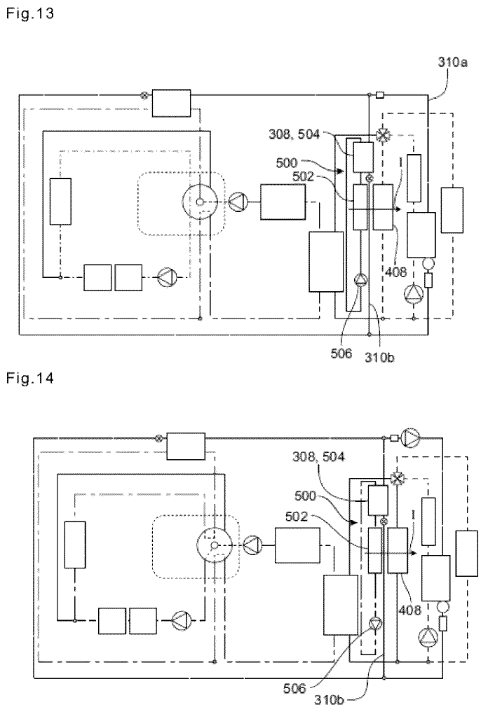

As a variant, according to the embodiments in FIGS. 13 to 18 and 27, said cooling exchanger 308 is formed by a third two-fluid exchanger 504, intended to exchange heat between said refrigerant and a heat transfer fluid circulating in a third circuit 500 of heat transfer fluid.

Said third circuit 500 of heat transfer fluid comprises a cooling radiator 502, intended to exchange heat between said heat transfer fluid circulating in the third circuit 500 of heat transfer fluid and said interior air stream I. Said cooling radiator 502 is configured to be positioned in the heating, ventilation and/or air conditioning unit. In the embodiment in FIGS. 13 to 18, it is upstream of the second interior exchanger 408 in the direction of circulation of the interior air stream I. Said third circuit 500 of heat transfer fluid further comprises a fourth pump 506.

In this third embodiment, it will be understood that not said refrigerant, but a heat transfer fluid, passes through the exchangers 408, 502 situated in the heating, ventilation and air conditioning unit. This is particularly advantageous when said refrigerant presents risks to the passengers of the vehicle, such as high-pressure or flammable refrigerants.

According to the embodiments in FIGS. 1 to 6 and 25, said refrigerant circuit 300 comprises a second bypass branch 310c, in parallel with said second two-fluid exchanger 402 along said main branch 310a. Said second bypass branch 310c comprises an exchanger 304, intended to exchange heat between said refrigerant and the interior air stream I. It therefore forms said second interior exchanger instead of the second interior exchanger 408 in the other embodiments. It is for example situated downstream of said first interior exchanger 308 in the direction of circulation of said interior air stream I. It is for example an interior condenser.

Here, said refrigerant circuit 300 further comprises a second expansion member 316, situated on said main loop 300a upstream of said first two-fluid exchanger 204 in the direction of circulation of the refrigerant in said main loop 300a.

In the example shown, said refrigerant circuit 300 further comprises a so-called refrigerant exchanger, configured to allow heat exchange between the refrigerant and itself. To this end, the refrigerant passes through said refrigerant exchanger in respective passes, being at different pressure levels in each pass, before entering the compressor 302 again. One of these passes 312a, namely the high-pressure pass, is in the main branch 310a, downstream of said second two-fluid exchanger 402. Another of these passes 312b, namely the low-pressure pass, is in the main branch 300a, upstream of said compressor 302.

Said refrigerant circuit 300 further comprises an accumulator 314 making it possible to store said refrigerant. Here, said accumulator is situated in said main branch 300a downstream of the low-pressure pass 312b of said refrigerant exchanger and upstream of said compressor 302 in the direction of circulation of the refrigerant in said main loop 300a.

According to the embodiment in FIGS. 1 to 6 and 25, said refrigerant circuit 300 further comprises first and second valves 320a, 320b allowing the refrigerant to circulate according to the desired operating modes. Here, they are respectively situated in said main branch 310a and the second bypass branch 310c in order to allow the refrigerant to circulate though said second two-fluid exchanger 402 and/or said second interior exchanger 304.

It will be noted that, in these different embodiments, said refrigerant circuit 300 remains relatively simple. For example, it does not comprise a reversible heat exchanger, that is, that operates alternately as a condenser and an evaporator.

The device according to the invention allows a very large number of operating modes by virtue of the different positions of the distribution member 10.

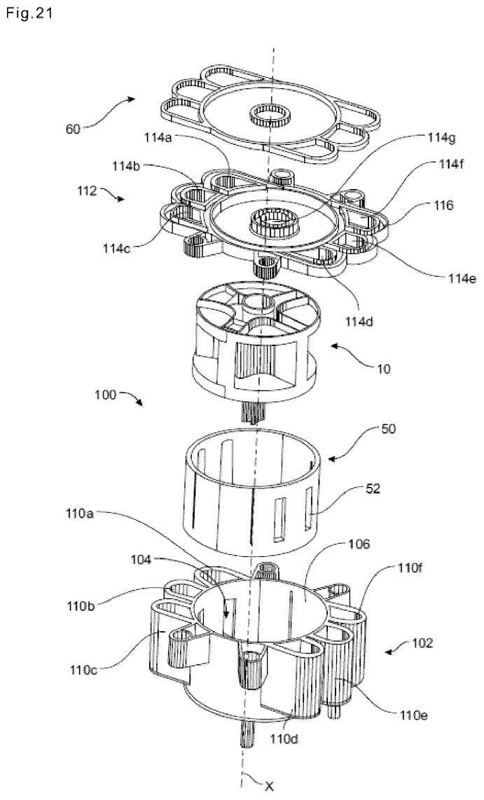

Before some of these are described, an example of a distribution system 100 and the distribution member 10 thereof, configured to be used in the device according to the invention, is described below, with reference to FIGS. 19 to 24.

In FIG. 19, the longitudinal axis about which said distribution member 10 is intended to be able to rotate is denoted X. The distribution member 10 comprises a body 12 and can optionally comprise a first plate 14 and a second plate 16, which are parallel and orthogonal to the longitudinal axis X, connected by the body 12. The body 12 has lateral edges 18, which in the present example are situated on a notional cylinder connecting peripheral edges 20 of the plates 14, 16. It will be understood that the first and second plates 14, 16, where present, define a diameter of the distribution member 10.

The distribution member 10 can be configured to rotate in a clockwise and/or anticlockwise direction. The distribution member 10 can be configured to rotate through more than 360°.

The body 12 of the distribution member 10 further has a first fluid distribution channel 22. This first distribution channel 22 extends axially along the longitudinal axis X. This is given to mean that the longitudinal axis X of rotation of the distribution member 12 passes through the distribution channel 22. Advantageously, the first distribution channel 22 is centered on the longitudinal axis X.

The body 12 also has a first chamber 24 in communication with the distribution channel 22. This first chamber 24 also opens radially.

As a result, the angular positions of the body 12 of the distribution member 10 can determine a passage for the fluid between a so-called axial inlet and/or outlet channel 108, and at least one from among so-called peripheral inlet and/or outlet channels 110a-110f of the distribution system 100 (see FIGS. 21 to 24), through the first chamber 24 and the first distribution channel 22.

The body 12 of the distribution member 10 can further have one or more second chambers 25a-25c opening radially such that at least some of the angular positions of the body 12 that the distribution member 10 can adopt also determine a passage for the fluid between different of the peripheral inlet and/or outlet channels 110a-110f of the valve 100, through the or at least one of the second chamber or chambers 25a-25c. In the examples shown, there are three second chambers 25a-25c.

The first chamber 24 and/or said second chamber or chambers 25a-25c advantageously extend angularly about the longitudinal axis X.

The distribution member 10, in particular the body 12, has a height h extending along the longitudinal axis X. It will be understood that the height h corresponds to a height of the first chamber 24 and, when they exist, of the second chamber or chambers 25a-25c.

Advantageously, the first distribution channel 22 is in communication with the first chamber 24 over all or part of the height h of the first chamber 24. This communication between the distribution channel 22 and the first chamber 24 takes place by means of an opening 23.

In addition, the distribution member 10, in particular the body 12, advantageously comprises a central portion 26. The body 12 can also comprise arms 28a, 28b connected to each other through the central portion 26. The arms advantageously extend substantially radially from the central portion to the lateral edges 18.

The chamber or chambers 24, 25a-25c is/are defined between two of the arms. In other words, when the distribution member 10 comprises a plurality of chambers 24, 25a-25c, the arms separate the chambers 24, 25a-25c from each other.

The arms 28a, 28b comprise walls 30a, 30b that extend along the longitudinal axis X from the first plate 14 toward the second plate 16.

The walls 30a of the arms 28a defining the first chamber 24 can be substantially planar. These arms 28a can further comprise outer ends, that is, opposite the central portion 26, having a bevel 32.

Here, the angular amplitude of the first chamber 24 is between 35 and 45 degrees.

The arms 28b defining at least one of the second chambers 25a-25c can form a curved base 34 on the central portion 26. This curved base 34 can be concave in order to facilitate the flow of the fluid.

Here, the angular amplitude of each second chamber 25a-25c is between 70 and 90 degrees.

Advantageously, at least one of the arms 28b comprises a through-channel 36 configured to connect one of the chambers with another of the adjacent chambers, as shown in particular in FIG. 20. With reference to the example shown, it will be understood that the chamber 25c is composed of two half-chambers connected to each other by the through-channel 36 to form an enlarged chamber, corresponding to the chamber 25c.

As shown in FIGS. 21 to 24, here, the distribution system 100 is formed by a valve.

The valve comprises a casing 102 defining a housing 104 for the distribution member 10. It will be understood that in this case the housing 104 has a diameter that is substantially identical to the diameter of the distribution member 10, with a clearance necessary for the rotation of the distribution member 10 in the housing 104. The lateral edges 18 of the body 12 are situated facing and in the immediate vicinity of, allowing for the clearance, an inner face of a lateral wall 106 of the casing 102.

The casing 102 is provided with peripheral inlet and/or outlet channels 110 opening laterally into the housing 104. In the examples shown, there are six peripheral inlet and/or outlet channels 110a-110f, namely a first inlet and/or outlet channel 110a, a second inlet and/or outlet channel 110b, a third inlet and/or outlet channel 110c, a fourth inlet and/or outlet channel 110d, a fifth inlet and/or outlet channel 110e, and a sixth inlet and/or outlet channel 110f.

Each of the peripheral inlet and/or outlet channels 110a-110f is formed as a radial protuberance of a lateral wall 106 of the casing 102. Advantageously, the peripheral inlet and/or outlet channels 110a-110f are distributed in two diametrically opposed groups. It will be understood, with reference to the figures, that a first group of peripheral inlet and/or outlet channels 110a-110c is positioned on one side of the casing, while a second group of peripheral inlet and/or outlet channels 110d-110f is positioned diametrically opposite the first group. Each of the first and second groups can comprise three of the peripheral inlet and/or outlet channels 110a-110f. The peripheral inlet and/or outlet channels 110a-110f of a group here extend over an angular interval of no more than 120 degrees.

Depending on its angular position, the first chamber 24 of the distribution member is or is not placed in communication with one or more of said peripheral inlet and/or outlet channels. Said first chamber 24 is intended to be in radial communication with the peripheral inlet and/or outlet channels 110a-110f. Advantageously, the first chamber 24 is intended to be in communication with no more than one of the peripheral channels 110a-110f, whatever the angular position of the body 12 of the distribution member 10.

The second chamber or chambers 25a-25c is/are in radial communication with the peripheral inlet and/or outlet channels 110a-110f. Advantageously, the second chamber or chambers 25a-25c is/are in communication with no more than two of the peripheral inlet and/or outlet channels 110a-110f, whatever the angular position of the body 12 of the distribution member 10.

The valve 100 can comprise an actuator (not shown), for example a stepper motor, for rotating the distribution member 10 about the longitudinal axis X. The distribution member 10 can in this case comprise a drive shaft, intended to be engaged with the actuator.

The valve 100 can also comprise a first annular gasket 50 situated between the distribution member 10 and the inner face of the lateral wall 106 of the casing 102. This first annular gasket 50 advantageously has apertures 52 having an outline that corresponds to an outline of a portion of the peripheral inlet and/or outlet channels 110a-110f that opens into the housing 104. Preferably, the first annular gasket 50 is fixedly mounted.

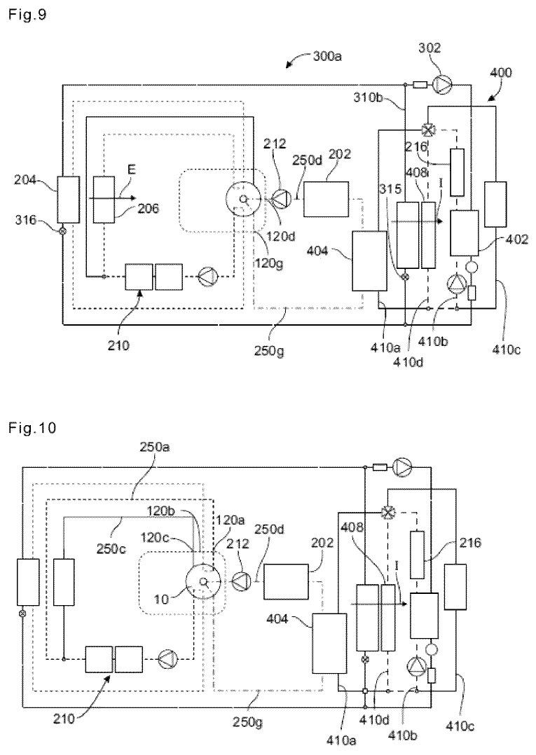

The valve 100 can further comprise a closure plate 112 that is designed to close the casing 102. This closure plate 112 is mounted orthogonally to the longitudinal axis X of the distribution member 10. The closure plate 112 can be fixed, in particular welded, to the casing 102. In the embodiment in FIGS. 8 and 9, the closure plate 112 is configured to be fixed to a fluid distribution support (not shown), in particular to a case of such a support.

The closure plate 112 advantageously comprises apertures 114a-114g situated in the axial continuation of the first distribution channel 22 and/or of the peripheral inlet and/or outlet channels 110a-110f. The aperture 114a is thus situated in the axial continuation of the channel 110a, the aperture 114b is situated in the axial continuation of the channel 110b, the aperture 114c is situated in the axial continuation of the channel 110c, the aperture 114d is situated in the axial continuation of the channel 110d, the aperture 114e is situated in the axial continuation of the channel 110e, the aperture 114f is situated in the axial continuation of the channel 110f, and the aperture 114g is situated in the axial continuation of the first distribution channel 22. Here, said apertures 114a-114g form the distribution orifices 120a-120g in communication with the branches 250a-250g of the first circuit 200 of first heat transfer fluid.

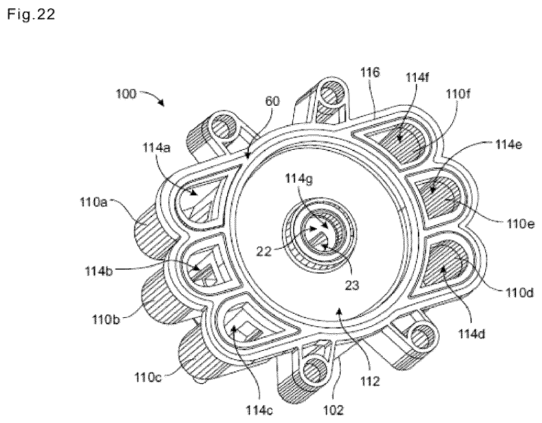

The valve 100 can comprise a second annular gasket 60 configured to provide a seal with the distribution support. In such a case, the closure plate 112 advantageously comprises, on an outer face, a groove 116. This groove 116 is designed to receive the second annular gasket 60. This second gasket 60 can be a flat seal in multiple parts, for example one part around each aperture 114a-114f and one part around the aperture 114g, as shown in the embodiment in FIGS. 21 and 22.

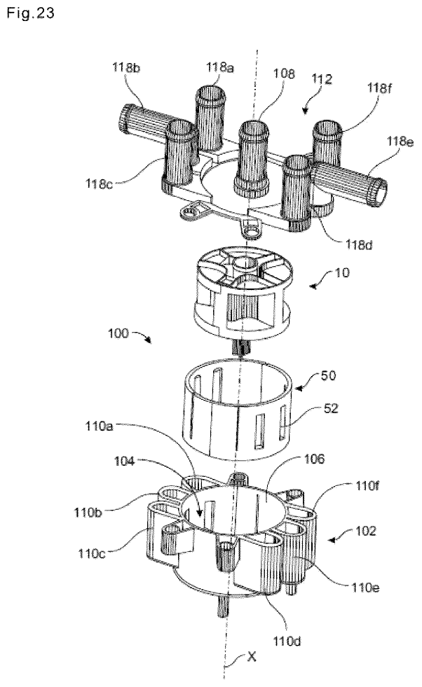

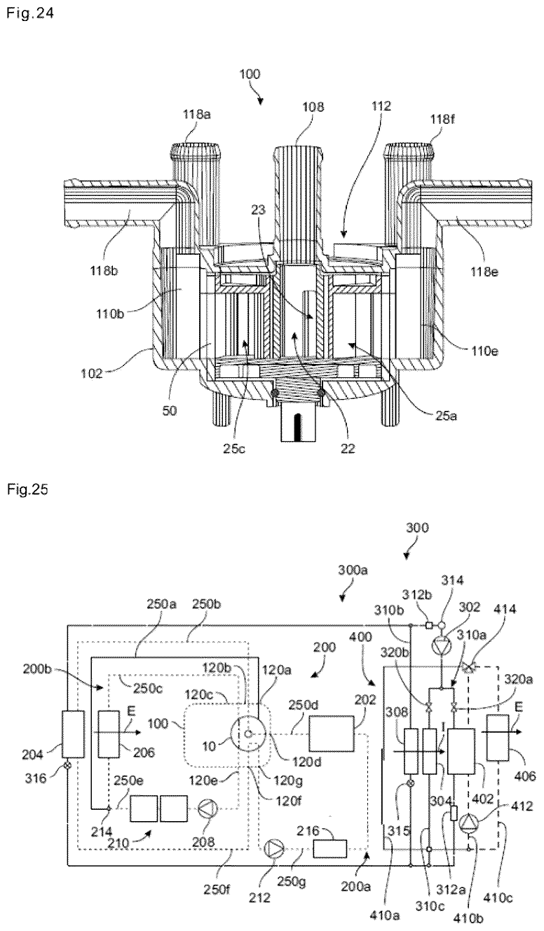

As an alternative, shown in FIGS. 23 and 24, the valve is intended to be used independently, by being connected to hoses for circulating the first fluid. The closure plate 112 comprises an axial inlet and/or outlet duct 108 in communication with the first channel 22. The closure plate can also comprise peripheral inlet and/or outlet ducts 118a-118f in communication, respectively, with the peripheral inlet and/or outlet channels 110a-110f. The axial or peripheral inlet and/or outlet ducts, 108 or 118a-118f, open into the distribution orifices 120a-120g in communication with the branches 250a-250g of the circuit 200 of first heat transfer fluid. They can be oriented along the longitudinal axis X and/or bent.

The closure plate 112 permits interchangeability of the valve 100 according to the type of distribution support used in a circuit of a fluid, in particular a heat transfer liquid.

With reference once more to FIGS. 1 to 18, different operating modes of the device according to the invention will now be described, with reference to respective positions of said distribution member 10.

In FIG. 1, the priority aim of the operating mode shown is to dissipate the heat released by said electrical energy storage system exchanger 202, via said refrigerant circuit 300, and moreover by dedicating the two-fluid exchanger 204 to heat exchange between the refrigerant and the portion of first heat transfer fluid that has passed through said electrical energy storage system exchanger 202. Such an operating mode makes it possible to cool the batteries during the rapid charging phases thereof, when such phases result in significant heating of the batteries due to the electric currents involved in said phases. To this end, the heat dissipated into the refrigerant is discharged by the second two-fluid exchanger 402 into the second circuit 400 of heat transfer fluid and then into the exterior air stream E by said second exterior exchanger 406.

More specifically, in this first operating mode, in the first loop 200a of said first circuit 200 of first heat transfer fluid, starting from the sixth distribution orifice 120g, the first heat transfer fluid is driven by the second pump 212, passes through said electric heat exchanger 216, which is inactive, and said specific exchanger 404, which is also inactive due to the absence of circulation of the heat transfer fluid in said first branch 410a of said second circuit 400 of heat transfer fluid. Said first fluid then enters said electrical energy storage system heat exchanger 202 before returning to the distribution system 100 by the first distribution orifice 120d. In the angular position in question, said distribution member 10 connects said first distribution orifice 120d to the second distribution orifice 120b. The first heat transfer fluid then continues its route along said first loop 200a, passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said first loop 200a. Through said first loop 200a, the heat released by said electrical energy storage system exchanger 202 into the first heat transfer fluid can thus be transferred to said two-fluid exchanger 204.

In the second loop 200b of said first circuit 200 of first heat transfer fluid, starting from the fourth distribution orifice 120e, the first heat transfer fluid is driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the fourth distribution orifice 120e to form said second loop 200b. It will be noted that, through said second loop 200b, any heat released by said electrical system exchanger 210 can thus be transferred to said first exterior exchanger 206 by the first heat transfer fluid. This heat can thus be released into the exterior air stream E by said first exterior exchanger 206, without however interfering with the heat released by said electrical energy storage system exchanger 202 as the latter is placed on the first loop 200a.

In this first operating mode, it will be understood that the first heat transfer fluid does not circulate in said seventh branch 250a, the seventh distribution orifice 120a not being connected to any other orifice by means of said distribution member 10.

For its part, the refrigerant, starting from the compressor 302, circulates along the main loop 300a, passing through said first valve 320a and said second two-fluid exchanger 402, dissipating its heat into said heat transfer fluid of the second circuit 400 of heat transfer fluid. It then passes through the second expansion member 316, which is active, and said first two-fluid exchanger 204, evaporating under the effect of the heat released by said first heat transfer fluid and originating from said electrical energy storage system exchanger 202. Said refrigerant then returns to the compressor 302 for another cycle. It will be noted that said refrigerant does not circulate in said first bypass branch 310b, said first expansion member 315 being closed.

According to one variant of this first operating mode, alternatively or additionally, the refrigerant takes the second bypass branch 310c, passing through said second valve 320b and said second interior exchanger 304. The latter thus allows the refrigerant to dissipate its heat into said interior air stream I. The dissipation power of the second two-fluid exchanger 402 and the second interior exchanger 304 can thus be combined.

In the second circuit 400 of heat transfer fluid, the fluid circulates in a loop through the second and third branches 410b, 410c to allow the heat captured in said second two-fluid exchanger 402 to be dissipated into said exterior air stream E by said second exterior exchanger 406.

In FIG. 2, the operating mode shown makes it possible to cool said electrical energy storage system exchanger 202 and said electrical system exchanger 210 by placing them on the same loop for circulating said first refrigerant, referred to as the single loop, by placing said two-fluid exchanger 204 and said first exterior exchanger 206 on said single loop. The heat released by said storage system exchanger 202 and said electrical system exchanger 210 can thus be dissipated both into the refrigerant, by said two-fluid exchanger 204, and into the exterior air stream E, by said first exterior exchanger 206, via said first heat transfer fluid. In addition, the power of said pumps 208, 212 is combined. Such an operating mode also makes it possible, if necessary, to cool the passenger compartment using said first interior heat exchanger 308. As in the preceding embodiment, the heat dissipated into the refrigerant is discharged by the second two-fluid exchanger 402 into the second circuit 400 of heat transfer fluid and then into the exterior air stream E by said second exterior exchanger 406.

More specifically, in this second operating mode, in the single loop of first heat transfer fluid, starting from the sixth distribution orifice 120g, the first heat transfer fluid is driven by the second pump 212 and passes through said electric heat exchanger 216, which is inactive, and said specific exchanger 404, which is also inactive due to the absence of circulation of the heat transfer fluid in said first branch 410a of said second circuit 400 of heat transfer fluid. Said first fluid then enters said electrical energy storage system heat exchanger 202 before returning to the distribution system 100 by the first distribution orifice 120d. In the angular position in question, said distribution member 10 connects said first distribution orifice 120d to the fourth distribution orifice 120e. The first heat transfer fluid is then driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the second distribution orifice 120b and said first heat transfer fluid then continues its route by passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said single loop.

In this second operating mode, as in the preceding mode, it will be understood that the first heat transfer fluid does not circulate in said seventh branch 250a, the seventh distribution orifice 120a not being connected to any other orifice by means of said distribution member 10.

For its part, the refrigerant circulates in said main loop 300a and, optionally, in the first bypass branch 310b, said first expansion member 315 being open and active in this case. It will be understood however that it does not circulate in said second bypass branch 310c, for example by virtue of said second valve 320b, which is closed.

Starting from the compressor 302, the refrigerant thus circulates along the main loop 300a, passing through said first valve 320a and said second two-fluid exchanger 402, dissipating its heat into said heat transfer fluid of the second circuit 400 of heat transfer fluid. It then passes through the second expansion member 316, which is active, and said first two-fluid exchanger 204, evaporating under the effect of the heat released by said first heat transfer fluid. Said refrigerant then returns to the compressor 302 for another cycle.

As a variant, when the refrigerant reaches the first bypass branch 310b, downstream of said main branch 310a, it splits between said main loop 300a, to enter said first two-fluid exchanger 204, and said second bypass branch 310c, to enter said first interior exchanger 308, before converging again upstream of said main branch 310a. In said first bypass branch, after expansion via the first expansion member 315, said refrigerant enters said first interior exchanger 308, taking the heat from said interior stream I, thus making it possible to cool it.

The heat transfer fluid of the second circuit 400 of heat transfer fluid circulates as in the preceding operating mode.

By virtue of said refrigerant circuit 300, the heat released by the first heat transfer fluid into said refrigerant, in said two-fluid exchanger 204, is thus dissipated into the exterior air stream E in said second exterior exchanger 406, by means of said second two-fluid exchanger 402 and the heat transfer fluid of the second circuit 400 of heat transfer fluid. In parallel, if necessary, in said first interior exchanger 308, the interior air stream I is cooled by releasing its heat into said refrigerant.

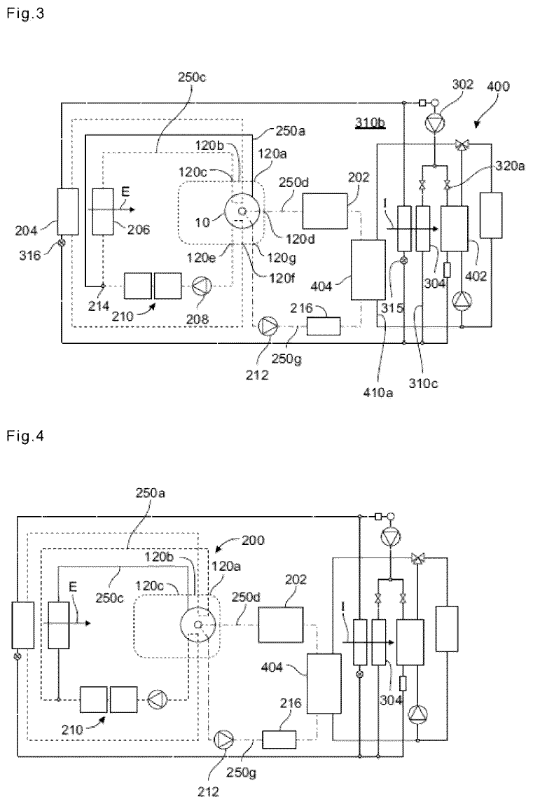

In FIG. 3, the operating mode shown makes it possible to heat the passenger compartment by releasing heat from the refrigerant into the interior air stream I through the second interior exchanger 304. Said heat preferably originates from the recovery of heat coming from the electrical system exchanger 210 and, by means of the first exterior exchanger 206, from the exterior air stream E, which is at a sufficient temperature, via the first heat transfer fluid and the two-fluid exchanger 204.

More specifically, in this third operating mode, in a first sub-circuit of said first circuit 200 of first heat transfer fluid, starting from the sixth distribution orifice 120g, the first heat transfer fluid is driven by the second pump 212, passes through said electric heat exchanger 216 and said specific exchanger 404, which is inactive due to the absence of circulation of the heat transfer fluid in said first branch 410a of said second circuit 400 of heat transfer fluid. Said first fluid then enters said electrical energy storage system heat exchanger 202 before returning to the distribution system 100 by the first distribution orifice 120d. In the angular position in question, said distribution member 10 directly connects said first distribution orifice 120d to the sixth distribution orifice 120g. Said first sub-circuit thus allows self-heating of the storage system and the homogenization of the temperature in the electrical energy storage system, referred to as “self-circulation” mode, the first refrigerant circulating in a closed loop without passing through a heat exchanger, which would lead to undesirable dissipation of the heat released by said storage system. If necessary, said electric heat exchanger 216 is active in order to accelerate the heating of said storage system via the first heat transfer fluid and said electrical energy storage system exchanger 202.

In a second sub-circuit of said first circuit 200 of first heat transfer fluid, starting from the fourth distribution orifice 120e, the first heat transfer fluid is driven by the first pump 208, passes through said electrical system exchanger 210, passes through said divergence point 214, and then takes the third branch 250c to pass through said first exterior heat exchanger 206 before returning to the distribution system 100 by the third distribution orifice 120c. In the angular position in question, said distribution member 10 connects said third distribution orifice 120c to the second distribution orifice 120b. The first heat transfer fluid then continues its route, passing through said two-fluid exchanger 204 to return to said distribution system 100 by the fifth distribution orifice 120f. In the angular position in question, said distribution member 10 connects said fifth distribution orifice 120f to the fourth distribution orifice 120e to form said second sub-circuit. Such circulation allows the heat recovery mentioned above.

Even more specifically, such an operating mode is advantageously used when the temperature of the first heat transfer fluid is below a temperature threshold and the temperature of the exterior air stream E is above this temperature threshold, in which case the first exterior heat exchanger 206 allows the first heat transfer fluid to recover heat from said exterior air stream E, which is warmer.

In this third operating mode, as in the preceding modes, it will be understood that the first heat transfer fluid does not circulate in said seventh branch 250a, the seventh distribution orifice 120a not being connected to any other orifice by means of said distribution member 10.

For its part, the refrigerant, starting from the compressor 302, circulates through said second bypass branch 310c. It will be understood however that it does not circulate through said second two-fluid exchanger 402, said first valve 320a being closed, or through said first bypass branch 310b, said first expansion member 315 being closed.

In other words, on leaving the compressor 302, the refrigerant passes through said second interior exchanger 304, condensing and dissipating its heat into said interior air stream I, thus heating the passenger compartment. It then passes through the second expansion member 316, which is active, and said two-fluid exchanger 204, evaporating under the effect of the heat released by said first heat transfer fluid. Said refrigerant then returns to the compressor 302 for another cycle.

As a variant, the refrigerant circulates alternatively or additionally in said first bypass branch 310b with expansion of said refrigerant in said first expansion member 315 with a view to dehumidifying the interior air stream I.

In this third operating mode, said second circuit 400 of heat transfer fluid is not active.

In FIG. 4, the operating mode is identical to the preceding mode apart from in that, in said first circuit 200 of first heat transfer fluid, said first heat transfer fluid passes through the seventh branch 250a instead of the third branch 250c. To this end, here, in the angular position in question, said distribution member 10 connects the second distribution orifice 120b and the seventh distribution orifice 120a instead of the third distribution orifice 120c.

In this fourth operating mode, as in the preceding mode, the passenger compartment is heated by releasing heat from the refrigerant into the interior air stream I through the second interior exchanger 304, said heat originating solely from the recovery of heat coming from the electrical system exchanger 210. This fourth operating mode is advantageously used to replace the preceding mode when the temperature of the exterior air stream E is insufficient, particularly when it is below said temperature threshold. The rest of the operation is preferably unchanged.

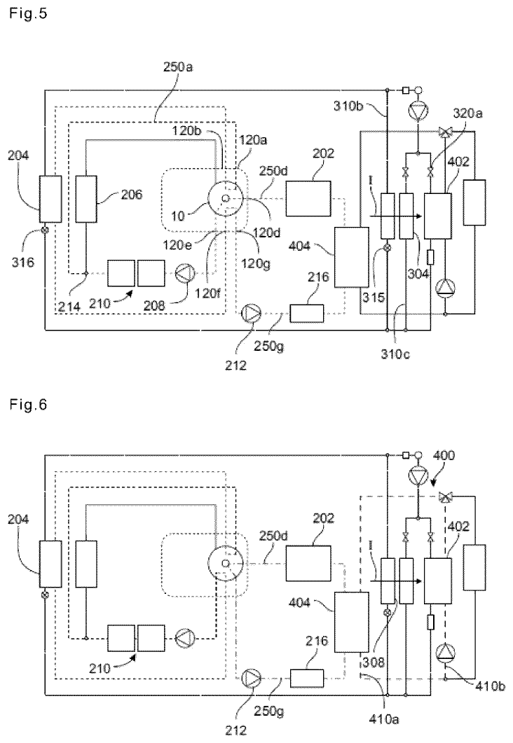

In FIG. 5, the operating mode shown makes it possible to heat the passenger compartment by releasing heat from the refrigerant into the interior air stream I through the second interior exchanger 304. Said heat preferably originates from the recovery of heat coming from the electrical energy storage system exchanger 202 and from the electrical system exchanger 210, via the first heat transfer fluid and the two-fluid exchanger 204.

More specifically, in this fifth operating mode, the first heat transfer fluid circulates once more in a single loop, but a different loop from the one in the second operating mode. Starting from the sixth distribution orifice 120g, the first heat transfer fluid is driven by the second pump 212, passes through said electric heat exchanger 216, which is active or inactive, and said specific exchanger 404, which is inactive due to the absence of circulation of the heat transfer fluid in said first branch 410a of said second circuit 400 of heat transfer fluid. Said first fluid then enters said electrical energy storage system heat exchanger 202 before returning to the distribution system 100 by the first distribution orifice 120d. In the angular position in question, said distribution member 10 connects said first distribution orifice 120d to the fourth distribution orifice 120e. The first heat transfer fluid is then driven by the first pump 208, passes through said electrical system exchanger 210, passes through said divergence point 214, and then takes the seventh branch 250a to bypass said first exterior heat exchanger 206 before returning to the distribution system 100 by the seventh distribution orifice 120a. In the angular position in question, said distribution member 10 connects said seventh distribution orifice 120a to the second distribution orifice 120b and said first heat transfer fluid then continues its route by passing through said two-fluid exchanger 204 to return to said distribution system 100 by the fifth distribution orifice 120f. In the angular position in question, said distribution member 10 connects said fifth distribution orifice 120f to the sixth distribution orifice 120g to form said corresponding single loop.

For its part, the refrigerant circulates through said second bypass branch 310c. It will be understood however that it does not circulate through said second two-fluid exchanger 402, said first valve 320a being closed, or through said first bypass branch 310b, said first expansion member 315 being closed.

In other words, on leaving the compressor 302, the refrigerant passes through said second interior exchanger 304, condensing and dissipating its heat into said interior air stream I, thus heating the passenger compartment. It then passes through the second expansion member 316, which is active, and said two-fluid exchanger 204, evaporating under the effect of the heat released by said first heat transfer fluid. Said refrigerant then returns to the compressor 302 for another cycle.

As a variant, the refrigerant circulates alternatively or additionally in said first bypass branch 310b with expansion of said refrigerant in said first expansion member 315 with a view to dehumidifying the interior air stream I.

In this fifth operating mode, said second circuit 400 of heat transfer fluid is not active.

In FIG. 6, the operating mode shown makes it possible to dissipate heat originating from said electrical system into said refrigerant via a first portion of the first heat transfer fluid passing through said first two-fluid exchanger 204. The heat from the refrigerant is used to heat the electrical energy storage system via said second two-fluid exchanger 402, said second circuit 400 of heat transfer fluid, said specific exchanger 404, and a second portion of said first heat transfer fluid passing through said storage system exchanger 202. Such an operating mode also makes it possible, if necessary, to cool the passenger compartment using said first interior heat exchanger 308.

More specifically, the first heat transfer fluid circulates in the same way as in the third and fourth operating modes (FIGS. 3 and 4), the only difference being that the specific exchanger 404 is active, the heat transfer fluid of the second circuit 400 of heat transfer fluid circulating in said first branch 410a of said second circuit 400 of heat transfer fluid.

The refrigerant circulates in an identical manner to that described with reference to the second operating mode (FIG. 2).

In the second circuit 400 of heat transfer fluid, said fluid circulates in a loop through the first and second branches 410a, 410b in order to allow the heat from the refrigerant captured in said second two-fluid exchanger 402 to be supplied, via said heat transfer fluid of the second circuit 400 of heat transfer fluid, to the first heat transfer fluid, in said second sub-circuit by means of said specific exchanger 404.

In FIG. 7, as in FIG. 1, the priority aim of the operating mode shown is to dissipate the heat released by said electrical energy storage system exchanger 202, via said refrigerant circuit 300, and moreover by dedicating the two-fluid exchanger 204 to heat exchange between the refrigerant and the portion of first heat transfer fluid that has passed through said electrical energy storage system exchanger 202. As stated above, such an operating mode makes it possible to cool the batteries during the rapid charging phases thereof, when such phases result in significant heating of the batteries due to the electric currents involved in said phases. To this end, the heat dissipated into the refrigerant is discharged by the second two-fluid exchanger 402 into the second circuit 400 of heat transfer fluid and then into the exterior air stream E by said second exterior exchanger 406.

More specifically, in this first operating mode, in the first loop 200a of said first circuit 200 of first heat transfer fluid, the only change in relation to the first embodiment relates to the circulation in the sixth and first branches 250g, 250d. Starting from the sixth distribution orifice 120g, the first heat transfer fluid passes through said specific exchanger 404, which is inactive due to the absence of circulation of the heat transfer fluid in said first branch 410a of said second circuit of heat transfer fluid. Said first fluid then enters said electrical energy storage system heat exchanger 202, driven by the second pump 212, before returning to the distribution system 100 by the first distribution orifice 120d. The rest of the circulation is identical to FIG. 1.

In the second loop 200b of said first circuit 200 of first heat transfer fluid, the circulation is identical to FIG. 1.

For its part, the refrigerant, starting from the compressor 302, circulates in said main loop 300a, passing through said second two-fluid exchanger 402, dissipating its heat into said heat transfer fluid of the second circuit 400 of heat transfer fluid. It then passes through the second expansion member 316, which is active, and said first two-fluid exchanger 204, evaporating under the effect of the heat released by said first heat transfer fluid and originating from said storage system exchanger 202. Said refrigerant then returns to the compressor 302 for another cycle. It will be noted that said refrigerant does not circulate in said first bypass branch 310b, said first expansion member 315 being closed.

In the second circuit 400 of heat transfer fluid, said fluid circulates in the second branch 410b of the second circuit 400 of heat transfer fluid, driven by said third pump 412, to enter said second two-fluid exchanger 402 and said electric exchanger 216, which is inactive. In said second two-fluid exchanger 402, said heat transfer fluid of the second circuit 400 of heat transfer fluid captures the heat from the refrigerant. Said heat transfer fluid of the second circuit 400 of heat transfer fluid then enters the third branch 410c of the second circuit 400 of heat transfer fluid to allow the heat captured in said second two-fluid exchanger 402 to be dissipated into said exterior air stream E by said second exterior exchanger 406. Said heat transfer fluid of the second circuit 400 of heat transfer fluid then returns to said second branch 410b of the second circuit 400 of heat transfer fluid.

As a variant, on leaving said second branch 410b of the second circuit 400 of heat transfer fluid, said fluid splits in order to circulate in parallel in said third branch 410c of the second circuit 400 of heat transfer fluid and in said fourth branch 410d of the second circuit 400 of heat transfer fluid before converging again on returning to said second branch 410b of the second circuit 400 of heat transfer fluid.

In the third branch 410c of the second circuit 400 of heat transfer fluid, as stated above, a first portion of the heat captured in said second two-fluid exchanger 402 is dissipated into said exterior air stream E by said second exterior exchanger 406.

In said fourth branch 410d, the heat transfer fluid of said second circuit 400 of heat transfer fluid passes through said second interior exchanger 408 and the other portion of the heat captured in said second two-fluid exchanger 402 is dissipated into said interior air stream I by said second interior exchanger 408.

In FIG. 8, as in FIG. 2, the operating mode shown makes it possible to cool said electrical energy storage system exchanger 202 and said electrical system exchanger 210 by placing them on the same loop for circulating said first refrigerant, referred to as the single loop, by placing said two-fluid exchanger 204 and said first exterior exchanger 206 on said single loop. The heat released by said storage system exchanger 202 and said electrical system exchanger 210 can thus be dissipated both into the refrigerant, by said two-fluid exchanger 202, and into the exterior air stream E, by said first exterior exchanger 206, via said first heat transfer fluid. In addition, the power of said pumps 208, 212 is combined. Such an operating mode also makes it possible, if necessary, to cool the passenger compartment using said first interior heat exchanger 308. As in the preceding embodiment, the heat dissipated into the refrigerant is discharged by the second two-fluid exchanger 402 into the second circuit 400 of heat transfer fluid and then into the exterior air stream E by said second exterior exchanger 406.

More specifically, in this second operating mode, in the single loop of first heat transfer fluid, the only change in relation to the first embodiment relates to the circulation in the sixth and first branches 250g, 250d. Starting from the sixth distribution orifice 120g, the first heat transfer fluid passes through said specific exchanger 404, which is inactive due to the absence of circulation of the heat transfer fluid in said first branch 410a of said second circuit of heat transfer fluid. Said first fluid then enters said electrical energy storage system heat exchanger 202, driven by the second pump 212, before returning to the distribution system 100 by the first distribution orifice 120d. The rest of the circulation is identical to FIG. 2.

For its part, the refrigerant circulates in said main loop 300a and, optionally, in the first bypass branch 310b, said first expansion member 315 being open and active in this case.

Starting from the compressor 302, the refrigerant thus circulates along the main loop 300a, passing through said second two-fluid exchanger 402, dissipating its heat into said heat transfer fluid of the second circuit 400 of heat transfer fluid. It then passes through the second expansion member 316, which is active, and said first two-fluid exchanger 204, evaporating under the effect of the heat released by said first heat transfer fluid. Said refrigerant then returns to the compressor 302 for another cycle.

As a variant, when the refrigerant reaches the first bypass branch 310b, downstream of said main branch 310a, it splits between said main loop 300a, to enter said first two-fluid exchanger 204, and said first bypass branch 310b, to enter said first interior exchanger 308, before converging again upstream of said main branch 310a. In said first bypass branch 310b, after expansion in the first expansion member 315, said refrigerant enters said first interior exchanger 308, taking the heat from said interior stream I, thus making it possible to cool it.

The heat transfer fluid of the second circuit 400 of heat transfer fluid circulates in a loop in said second and third branches 410b, 410c of said second circuit 400 of heat transfer fluid.

By virtue of said refrigerant circuit 300, the heat released by the first heat transfer fluid into said refrigerant, in said two-fluid exchanger 204, is thus dissipated into the exterior air stream E in said second exterior exchanger 406, by means of said second two-fluid exchanger 402 and the heat transfer fluid of the second circuit 400 of heat transfer fluid. In parallel, in said first interior exchanger 308, the interior air stream I is cooled by releasing its heat into said refrigerant.

In FIG. 9, as in FIG. 3, the operating mode shown makes it possible to heat the passenger compartment by releasing heat from the refrigerant into the interior air stream I through the second interior exchanger 408. Said heat preferably originates from the recovery of heat coming from the electrical system exchanger 210 and, by means of the first exterior exchanger 206, from the exterior air stream E, which is at a sufficient temperature, via the first heat transfer fluid and the two-fluid exchanger 204.

More specifically, in this third operating mode, in the first sub-circuit of said first circuit 200 of first heat transfer fluid, the only change in relation to the first embodiment relates to the circulation in the sixth and first branches 250g, 250d. Starting from the sixth distribution orifice 120g, the first heat transfer fluid passes through said specific exchanger 404, which is inactive due to the absence of circulation of the heat transfer fluid in said first branch 410a of said second circuit of heat transfer fluid. Said first fluid then enters said electrical energy storage system heat exchanger 202, driven by the second pump 212, before returning to the distribution system 100 by the first distribution orifice 120d. The rest of the circulation is identical to FIG. 3.

The circulation of the first heat transfer fluid in said second sub-circuit is also identical to FIG. 3.

For its part, the refrigerant, starting from the compressor 302, circulates through said main loop 300a. It will be understood however that it does not circulate through said first bypass branch 310b, said first expansion member 315 being closed.

In other words, on leaving the compressor 302, the refrigerant passes through said second two-fluid exchanger 402, condensing and dissipating its heat into said heat transfer fluid of the second circuit 400 of heat transfer fluid. It then passes through the second expansion member 316, which is active, and said two-fluid exchanger 204, evaporating under the effect of the heat released by said first heat transfer fluid. Said refrigerant then returns to the compressor 302 for another cycle.

As a variant, the refrigerant circulates alternatively or additionally in said first bypass branch 310b with expansion of said refrigerant in said first expansion member 315 with a view to dehumidifying the interior air stream I.

In this third operating mode, said second circuit 400 of heat transfer fluid circulates in a loop in said second and fourth branches 410b, 410d.

By virtue of said refrigerant circuit 300, the heat released by the first heat transfer fluid into said refrigerant, in said two-fluid exchanger 204, is thus dissipated into the interior air stream I in said second interior exchanger 408, by means of said second two-fluid exchanger 402 and the heat transfer fluid of the second circuit 400 of heat transfer fluid. This makes it possible to heat said interior air stream I and, subsequently, the passenger compartment of the vehicle.

As a variant, the heat transfer fluid also circulates in said third branch 410c of the second circuit 400 of heat transfer fluid to expel the excess heat into said exterior air stream E by means of said second exterior exchanger 406.

In FIG. 10, as in FIG. 4, the operating mode is identical to the preceding mode apart from in that, in said first circuit 200 of first heat transfer fluid, said first heat transfer fluid passes through the seventh branch 250a instead of the third branch 250c. To this end, here, in the angular position in question, said distribution member 10 connects the second distribution orifice 120b and the seventh distribution orifice 120a instead of the third distribution orifice 120c.

In this fourth operating mode, the passenger compartment is also heated by releasing heat from the refrigerant into the interior air stream I through the second interior exchanger 408, said heat originating solely from the recovery of heat coming from the electrical system exchanger 210. This fourth operating mode is advantageously used to replace the preceding mode when the temperature of the exterior air stream E is insufficient, particularly when it is below said temperature threshold. The rest of the operation is preferably unchanged.

In FIG. 11, as in FIG. 5, the operating mode shown makes it possible to heat the passenger compartment by releasing heat from the refrigerant into the interior air stream I through the second interior exchanger 408. Said heat preferably originates from the recovery of heat coming from the electrical energy storage system exchanger 202 and from the electrical system exchanger 210, via the first heat transfer fluid, the first two-fluid exchanger 204, the refrigerant circuit 300, the second two-fluid exchanger 402, and the second circuit 400 of heat transfer fluid.

More specifically, in this fifth operating mode, the first heat transfer fluid circulates once more in a single loop, but a different loop from the one in the second operating mode. The only change in relation to the first embodiment relates to the circulation in the sixth and first branches 250g, 250d. Starting from the sixth distribution orifice 120g, the first heat transfer fluid passes through said specific exchanger 404, which is inactive due to the absence of circulation of the heat transfer fluid in said first branch 410a of said second circuit 400 of heat transfer fluid. Said first fluid then enters said electrical energy storage system heat exchanger 202, driven by said second pump 212, before returning to the distribution system 100 by the first distribution orifice 120d. The rest of the circulation is identical to FIG. 5.

For its part, the refrigerant circulates in said main loop 300a. It will be understood however that it does not circulate in said first bypass branch 310b, said first expansion member 315 being closed.

In other words, on leaving the compressor 302, the refrigerant passes through said second two-fluid exchanger 402, condensing and dissipating its heat into said heat transfer fluid of the second circuit 400 of heat transfer fluid. It then passes through the second expansion member 316, which is active, and said two-fluid exchanger 204, evaporating under the effect of the heat released by said first heat transfer fluid. Said refrigerant then returns to the compressor 302 for another cycle.

As a variant, the refrigerant circulates alternatively or additionally in said first bypass branch 310b with expansion of said refrigerant in said first expansion member 315 with a view to dehumidifying the interior air stream I.

In this fifth operating mode, said second circuit 400 of heat transfer fluid operates as in the third and fourth operating modes (FIGS. 9 and 10).

By virtue of said refrigerant circuit 300, the heat released by the first heat transfer fluid into said refrigerant, in said two-fluid exchanger 204, is thus dissipated into the interior air stream I in said second interior exchanger 408, by means of said second two-fluid exchanger 402 and the heat transfer fluid of the second circuit 400 of heat transfer fluid. This makes it possible to heat said interior air stream I and, subsequently, the passenger compartment of the vehicle.

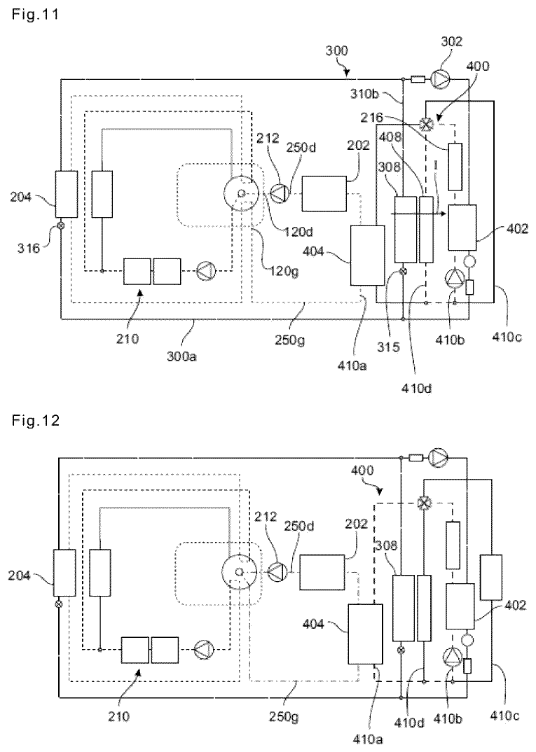

In FIG. 12, as in FIG. 6, the operating mode shown makes it possible to dissipate heat originating from said electrical system 210 into said refrigerant via a first portion of the first heat transfer fluid and said first two-fluid exchanger 204. The heat from the refrigerant is used to heat the electrical energy storage system via said second two-fluid exchanger 402, said second circuit 400 of heat transfer fluid, said specific exchanger 404, and a second portion of said first heat transfer fluid. Such an operating mode also makes it possible, if necessary, to cool the passenger compartment using said first interior heat exchanger 308.

More specifically, the first heat transfer fluid circulates in the same way as in the third and fourth operating modes (FIGS. 9 and 10), the only difference being that the specific exchanger 404 is active, the heat transfer fluid of the second circuit 400 of heat transfer fluid circulating in said first branch 410a of said second circuit 400 of heat transfer fluid.

The refrigerant circulates in an identical manner to that described with reference to the second operating mode (FIG. 8).

In the second circuit 400 of heat transfer fluid, said fluid circulates in a loop through the first and second branches 410a, 410b in order to allow the heat from the refrigerant captured in said second two-fluid exchanger 402 to be supplied, via said heat transfer fluid of the second circuit 400 of heat transfer fluid, to the first heat transfer fluid, in said second sub-circuit by means of said specific exchanger 404.

The operating modes shown in FIGS. 13 to 18 are respectively identical to those shown in the operating modes shown in FIGS. 7 to 12, the difference lying in the cooling and/or dehumidifying of the interior air stream I.

More specifically, when such cooling and/or such dehumidifying is desired, as in the operating modes in FIGS. 14, 17, and 18 in particular, said third circuit 500 of heat transfer fluid is active so that the heat taken from said interior air stream I by said cooling radiator 502 is transferred to said refrigerant via said heat transfer fluid of said third circuit 500 of heat transfer fluid and said third two-fluid exchanger 504.

According to the embodiment in FIGS. 25 to 27, it will be noted that said sixth branch 250g is optionally connected directly to said storage system exchanger 202 from said sixth distribution orifice 120g, unless it is provided with said second pump 212 and/or said electric heat exchanger 216.

Still in the embodiments in FIGS. 25 to 27, said second circuit 400 of heat transfer fluid of said first branch 410a does not comprise an exchanger. As a variant, said second circuit 400 of heat transfer fluid is solely provided with the second and third branches 410b, 410c, or even said fourth branch 410d.

In these embodiments in FIGS. 25 to 27, the operating modes described with reference to FIGS. 1 to 5, 7 to 11, and 13 to 17 are respectively possible, but it will be understood that the operating modes in FIGS. 6, 12, and 18 are not.

As stated above, all of the preceding operating modes, although advantageous, are given solely by way of example, and the device according to the invention allows numerous other modes, particularly by virtue of said multi-way distribution system 100.

1. A thermal regulation device comprising a first circuit of first heat transfer fluid, said first circuit of first heat transfer fluid comprising a system for distributing said first heat transfer fluid having a plurality of orifices for distributing said first heat transfer fluid, said first circuit of first heat transfer fluid further comprising a plurality of branches respectively connected to one of said distribution orifices, said distribution system being configured to adopt different positions respectively intended to place at least some of said branches in communication with each other, said distribution system comprising a distribution member, said distribution member being intended to be able to rotate about a longitudinal axis in order to selectively feed said branches to be connected to each other as a function of angular positions of said distribution member, at least two of said branches being connected to an exchanger, referred to as the first two-fluid exchanger, intended to exchange heat with a refrigerant, said device comprising a second circuit of heat transfer fluid, said second circuit of heat transfer fluid comprising an exchanger, referred to as the second two-fluid exchanger, intended to exchange heat with said refrigerant.

2. The device as claimed in claim 1, comprising a so-called specific heat exchanger, intended to exchange heat between the first heat transfer fluid and the heat transfer fluid circulating in said second circuit.

3. The device as claimed in claim 1, configured so that said heat transfer fluid circulating in said second circuit is the same type as said first heat transfer fluid.

4. The device as claimed in claim 1, wherein said first circuit of first heat transfer fluid or said second circuit of heat transfer fluid further comprises a so-called electric heat exchanger, intended to heat said fluid using an electric current.

5. The device as claimed in claim 2, wherein, in said first circuit of first heat transfer fluid:
a first of said branches comprises a heat exchanger, referred to as the electrical energy storage system heat exchanger,
a second of said branches is connected to said first two-fluid exchanger,
a third of said branches comprises an exchanger, referred to as the first exterior exchanger, intended to exchange heat with a second heat transfer fluid,
a fourth of said branches comprises a first pump and, optionally, a heat exchanger, referred to as the electrical system heat exchanger,
a fifth of said branches is connected to said first two-fluid exchanger,
a sixth of said branches comprises said specific exchanger, or even a second pump, and/or
a seventh of said branches is configured to bypass the third branch.

6. The device as claimed in claim 5, wherein said first circuit of first heat transfer fluid is configured so that one of the angular positions of the distribution member, referred to as the first position, makes it possible to form a first loop comprising said first, second, fifth, and sixth branches and a second loop comprising said third and fourth branches.

7. The device as claimed in claim 2, wherein said second circuit of heat transfer fluid comprises:
a first branch comprising said specific exchanger,
a second branch, situated in parallel with said first branch of said second circuit of heat transfer fluid, said second branch of the second circuit of heat transfer fluid comprising said second two-fluid exchanger,
a third branch, situated in parallel with said first branch of said second circuit of heat transfer fluid, said third branch of the second circuit of heat transfer fluid comprising an exchanger, referred to as the second exterior exchanger, intended to exchange heat between said first fluid and a so-called exterior air stream.

8. The device as claimed in claim 7, wherein said second circuit of heat transfer fluid comprises a fourth branch, situated in parallel with said first branch of said second circuit of heat transfer fluid, said fourth branch of the second circuit of heat transfer fluid comprising an exchanger, allowing heat exchange between said heat transfer fluid of said second circuit of heat transfer fluid and a so-called interior air stream.

9. The device as claimed in claim 1, wherein said device comprises a refrigerant circuit, said refrigerant circuit comprising said first and second two-fluid exchangers.

10. The device as claimed in claim 9, wherein said refrigerant circuit comprises a main loop comprising, in a direction of circulation of said refrigerant in said main loop, a compressor, said second two-fluid exchanger, an expansion member, and said first two-fluid exchanger, said main loop comprising a so-called main branch, provided with said compressor and said second two-fluid exchanger.

11. The device as claimed in claim 10, wherein said refrigerant circuit comprises a first bypass branch, situated in parallel with said main branch, said first bypass branch comprising a so-called cooling exchanger, intended to directly or indirectly cool a so-called interior air stream.

12. The device as claimed in claim 11, wherein said cooling exchanger comprises a third two-fluid exchanger, intended to exchange heat between said refrigerant and a heat transfer fluid circulating in a third circuit of heat transfer fluid, said third circuit of heat transfer fluid comprising a cooling radiator, intended to exchange heat between said heat transfer fluid circulating in the third circuit of heat transfer fluid and said interior air stream.

13. The device as claimed in claim 11, wherein said refrigerant circuit comprises a second bypass branch, in parallel with said second two-fluid exchanger, said second bypass branch comprising an exchanger, intended to exchange heat between said refrigerant and the interior air stream.

14. The device as claimed in claim 1, wherein said distribution member comprises a body having:
a first fluid distribution channel extending axially along the longitudinal axis, and
a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel.

15. The device as claimed in claim 14, wherein the body has one or more second chambers opening radially such that angular positions of said body determine a passage for the fluid between different of said peripheral inlet and/or outlet channels of said distribution system, through the or at least one of the second chamber or chambers, wherein the first chamber is intended to communicate with no more than one of the peripheral channels whatever the angular position of the body.

16. The device as claimed in claim 2, configured so that said heat transfer fluid circulating in said second circuit is the same type as said first heat transfer fluid.

17. The device as claimed in claim 2, wherein said first circuit of first heat transfer fluid or said second circuit of heat transfer fluid further comprises a so-called electric heat exchanger, intended to heat said fluid using an electric current.

18. The device as claimed in claim 12, wherein said refrigerant circuit comprises a second bypass branch, in parallel with said second two-fluid exchanger, said second bypass branch comprising an exchanger, intended to exchange heat between said refrigerant and the interior air stream.

19. The device as claimed in claim 2, wherein said distribution member comprises a body having:
a first fluid distribution channel extending axially along the longitudinal axis, and
a first chamber in communication with said first distribution channel, said first chamber opening radially,
such that angular positions of said body determine a passage for the fluid between a so-called axial inlet and/or outlet channel and at least one from among so-called peripheral inlet and/or outlet channels of the distribution system, through the first chamber and the first distribution channel.

20. The device as claimed in claim 3, wherein said first circuit of first heat transfer fluid or said second circuit of heat transfer fluid further comprises a so-called electric heat exchanger, intended to heat said fluid using an electric current.
